(19) United States
(12) Patent Application Publication
(10) Pub. No.: US 2011/0155665 A1
(43) Pub. Date: Jun. 30, 2011

(54) Method and System for High Recovery Water Desalting

(75) Inventors: Yoram Cohen, Los Angeles, CA (US); Brian C. McCool, Los Angeles, CA (US); Anditya Rahardianto, Los Angeles, CA (US)

(73) Assignee: THE REGENTS OF THE UNIVERSITY OF CALIFORNIA, Oakland, CA (US)

(21) Appl. No.: 12/997,568

(22) PCT Filed: Jun. 9, 2009
(86) PCT No.: PCT/US09/46741

§ 371 Date: Mar. 21, 2011

Related U.S. Application Data
(60) Provisional application No. 61/060,788, filed on Jun. 11, 2008.

(51) Int. Cl. C02F 9/02; C02F 1/44; C02F 1/52

(52) U.S. Cl. 210/638; 210/714

(57) ABSTRACT

A method of desalting an aqueous solution includes performing a demineralization process on a concentrate solution to produce a demineralized solution and performing a desalting process. A method of recovering an aqueous solution includes performing a first membrane based separation process on a feed stream to produce a permeate stream and a concentrate stream, performing a demineralization process on the concentrate stream to produce a solid phase and a liquid phase, separating the solid phase from the liquid phase, and performing a second membrane based separation process on the liquid phase. The demineralization process includes adding chemical additives to induce calcium carbonate precipitation and subsequently adding gypsum seeds to the concentrate stream.

### CROSS REFERENCE TO RELATED APPLICATION

This application claims the benefit of U.S. Provisional Application Ser. No. 61/060,788, entitled “Method and System for High Recovery Water Desalting,” filed on Jun. 11, 2008, the disclosure of which is incorporated herein by reference in its entirety.

### FIELD OF THE INVENTION

The invention relates to a water desalting process. More particularly, the invention relates to a multi-step process for removing salt from water that includes at least one desalting step and a demineralization step.

### BACKGROUND

Processes for the removal of salt from saline solutions are desirable, for example, to produce potable water.

Known approaches for membrane desalination of saline solutions include reverse osmosis desalting as well as integrating membrane-based desalting processes with chemical demineralization processes. Such known approaches generally involve the following steps: 1) primary desalting of feed solution up to a given permeate product recovery, 2) removal of sparingly soluble inorganic salts as solids from the concentrate of primary desalting to produce treated concentrate, and 3) further desalting of treated concentrate by recycling to primary desalting or by utilizing secondary desalting. Additionally, concentrate from a secondary desalting step can be recycled to the inorganic-salt removal step. Also in some known desalinization approaches, a switch in strategy (from suppression of scaling to removal of inorganic salts and vice versa) is enabled by controlling inorganic crystallization processes using chemical reagents, additives, or by forced concentration. Acid is typically added to the feed stream to the membrane-based desalting steps to increase the solubility of certain mineral salts such as calcium carbonate and therefore avert membrane scaling by this mineral salt. In addition, scale-inhibitor (antiscalants) can also be added to these feed streams to kinetically suppress membrane scaling. For the desalting steps, RO membrane desalting for source water of high mineral scaling propensity typically dose acid and antiscalants on the basis of inorganic salts solubility.

Additionally, to precipitate inorganic salts and to remove them by solid-liquid separation, some known desalinization processes use one of the following approaches to treat desalination concentrate: 1) adding a reagent that will stoichiometrically react with inorganic salts and form solid precipitate; 2) contacting with inorganic seeds leading to crystallization on seeds and therefore desupersaturation of the concentrate stream; 3) using a separate membrane-concentrator loop for forcing the concentration of a concentrate stream, leading to sufficiently high supersaturation levels to cause fast precipitation. Each of these approaches has downsides. In approach 1, the reagent dose is added in an amount stoichiometric to the amount of inorganic salt removed. Consequently, this method is chemically intensive and produces high amounts of sludge in the treatment of certain feed solutions, such as agricultural drainage or mine waters. Problems have been reported with approach 2 due to poisoning of inorganic seeds by organics/antiscalants, leading to very slow desupersaturation. Various methods have been proposed to deactivate antiscalants prior to desupersaturation, including chelation, coagulation, and oxidation. These methods however generally use reagents and additives that are either toxic, may lead to formation of toxic materials, may lead to fouling in subsequent membrane-desalting operation, and/or are expensive. Approach 3 involves the use of a separate membrane concentrator loop that can tolerate fouling/scaling. Consequently, the approach typically involves the use of membrane modules that are space intensive. Moreover, the use of frequent membrane cleaning and deterioration of the membrane active layer can make this approach time consuming and economically unattractive.

Thus, a need exists for a process that can effectively and continuously recover aqueous solutions from saline solutions.

### SUMMARY

A continuous-flow chemical process, utilizing membrane-based separations and chemical precipitation unit operations, is disclosed for the recovery of aqueous solutions of low salinity/tailored composition from saline solutions (i.e., desalting), the production of inorganic salts from saline solutions, and/or the minimization of concentrated saline solution byproducts; secondarily, the disclosed processes can be used to remove organics and polymeric additives (e.g., scale inhibitors, antiscalants, polyelectrolytes, etc.).

The disclosed membrane-based desalting steps serve to recover low salinity solutions from high salinity solutions and to increase the supersaturation of inorganic salts. In one embodiment, to ensure that inorganic salts are kept in the dissolved state during the desalting steps (i.e., to mitigate membrane mineral scaling), the disclosed composition of the feed saline solution is tailored using various chemical additives that suppress mineral scale formation (e.g., acid and antiscalants).

Chemical demineralization steps, which are integrated between membrane-based desalting steps, serve to desupersaturate the concentrate from the membrane-desalting steps and therefore to remove scale-forming inorganic salts from the aqueous phase as solids. Each chemical demineralization step is initiated by removing precipitation retarders (e.g., scale inhibitors) from the aqueous-phase. This allows subsequent desupersaturation of the concentrate via growth/coprecipitation of inorganic salts on added inorganic seeds. For this chemical demineralization approach, the use of chemical reagents can be limited to the removal of precipitation retarders, thereby minimizing the chemical costs. The resulting precipitated solids are readily separable from the aqueous phase, can be recycled into the chemical demineralization step to be reused as inorganic seeds, and may contain calcium carbonate. The disclosed process is capable of achieving very high volume yield (e.g., in excess of 90-95%) from saline solutions.

In one embodiment, a method of desalting an aqueous solution includes performing a demineralization process on a concentrate solution to produce a demineralized solution and performing a desalting process on the demineralized solution. The demineralization process includes contacting the concentrate solution with at least one of an adsorbent and a co-precipitant and contacting the concentrate solution with inorganic seeds.

In another embodiment, a method of recovering an aqueous solution includes

performing a first membrane based separation process on a feed stream to produce a permeate stream and a concentrate stream, performing a demineralization process on the concentrate stream to produce a solid phase and a liquid phase, separating the solid phase from the liquid phase, and performing a second membrane based separation process on the liquid phase. The demineralization process includes adding at least one of an adsorbent and a co-precipitant to the concentrate stream and adding inorganic seeds to the concentrate stream.

In another embodiment, a method of desalting includes performing a separation process on a feed stream to produce a permeate stream and a concentrate stream, and performing a demineralization process on the concentrate stream to produce a solid phase and a liquid phase. The demineralization process includes inducing calcium carbonate precipitation and contacting the concentrate stream with gypsum seeds.

In another embodiment, a method of treating an aqueous solution includes removing antiscalants from the aqueous solution; contacting the aqueous solution with inorganic seeds; and performing a separation process on the aqueous solution.

### BRIEF DESCRIPTION OF THE DRAWINGS

For a better understanding of the nature and objects of some embodiments of the invention, reference should be made to the following detailed description taken in conjunction with the accompanying drawings.

FIG. 1 is a schematic illustration of a desalting system according to an embodiment of the invention.

FIG. 2 is a schematic illustration of a demineralization step according to an embodiment of the invention.

FIG. 3 illustrates the overall recovery of primary reverse osmosis according to an embodiment of the invention.

FIG. 4 illustrates the overall reverse osmosis recovery with the aid of secondary reverse osmosis desalting after accelerated gypsum precipitation and primary RO desalting according to an embodiment of the invention.

FIG. 5 illustrates a system for accelerated gypsum precipitation for primary reverse osmosis concentrate desupersaturation according to an embodiment of the invention.

FIG. 6 illustrates the removal of polyacrilic acid by CaCO₃ absorption/co-precipitation according to an embodiment of the invention.

FIG. 7 illustrates a process for water recovery (water desalination) via accelerated chemical precipitation according to an embodiment of the invention.

FIG. 8 illustrates a process for water recovery (water desalination) via accelerated gypsum precipitation according to an embodiment of the invention.

FIG. 9 illustrates the desupersatuation of the solution by gypsum seeding according to an embodiment of the invention.

FIG. 10 illustrates a process for inducing precipitation by adding NaOH and/or Na₂CO₃ as in accelerated chemical precipitation (ACP) or by adding CaSO₄ as in accelerated gypsum precipitation (AGP) according to an embodiment of the invention.

FIG. 11 illustrates the accelerated gypsum precipitation process according to embodiment of the invention through antiscalant deactivation followed by gypsum seeding.

FIG. 12 illustrates a process for accelerated gypsum precipitation according to an embodiment of the invention.

FIG. 13 illustrates the results of accelerated gypsum precipitation according to an embodiment of the invention.

FIGS. 14 and 14A illustrate PAA removal according to an embodiment of the invention.

FIG. 15 illustrates product water recovery process according to an embodiment of the invention.

FIG. 16 illustrates a process for desupersaturation via accelerated gypsum precipitation (AGP) according to an embodiment of the invention.

FIG. 17 illustrates the process of accelerated chemical precipitation according to an embodiment of the invention.

FIG. 18 illustrates the process of accelerated gypsum precipitation according to an embodiment of the invention.

FIGS. 19-21 illustrate processes according embodiments of the invention.

FIG. 22 illustrates the results of various processes according to embodiments of the invention.

FIG. 23 illustrates accelerated gypsum precipitation process according to an embodiment of the invention.

FIG. 24 illustrates a process according to an embodiment of the invention.

FIG. 25 illustrates a process for accelerated gypsum precipitation according to an embodiment of the invention.

FIG. 26 illustrates a demineralization process according to an embodiment of the invention.

### DETAILED DESCRIPTION

### Definitions

The following definitions apply to some of the aspects described with respect to some embodiments of the invention. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the terms “optional” and “optionally” mean that the subsequently described event or circumstance may or may not occur and that the description includes instances where the event or circumstance occurs and instances in which it does not.

### Water Recovery Process

The objective of some embodiments of the invention is to continuously, sustainably, and inexpensively recover product water of low salinity from a feed solution of high salinity (desalting), with capability of reaching recovery level in excess of 90%-95% (i.e., near zero liquid waste discharge). The feed solution can be any aqueous solution containing soluble and sparingly soluble inorganic salts, including but not limited to brackish/contaminated waters in natural environments, wastewaters (industrial, agricultural, municipal, mining, etc), and seawater. The composition and concentration of dissolved inorganic salts in the product solution can be tailored to comply with pertinent environmental regulations, drinking water standards (e.g., EPA secondary drinking water standard of 500 mg/L total dissolved solids), agricultural irrigation needs, or specified end user requirements. Related objectives include providing a process that removes dissolved inorganic salt using inexpensive reagents and minimal amounts of chemical additives, that minimizes the use of reagents that can reduce the efficiency of the process (e.g., aluminum, iron, etc), that minimizes or eliminates the introduction of unwanted, toxic, or dangerous chemical species such as hydroxyl radicals, that minimizes problems associated with fouling and inorganic salt scaling of membranes, that has advanced online monitoring and control systems so that the process meets specified process performance goals and can automatically respond to variations in the process and process streams by various methods (periodic cleaning cycles, adjustment of stream flow rates and proportions, etc.), that has the capability to sequester and transform gaseous CO₂ (of atmospheric, flue gas, or other synthetic origins) to solid calcium carbonate, that produces inorganic salts of sufficient level of purity with commercial value, that minimizes the volume of concentrate by-products to allow cost-effective waste disposal or processing, that provides mechanisms for organics/scale-inhibitor removal to improve the kinetics of inorganic salt removal via precipitation/co-precipitation/seeded-growth methods, that can be designed to operate at ambient temperature, and that has a small foot-print.

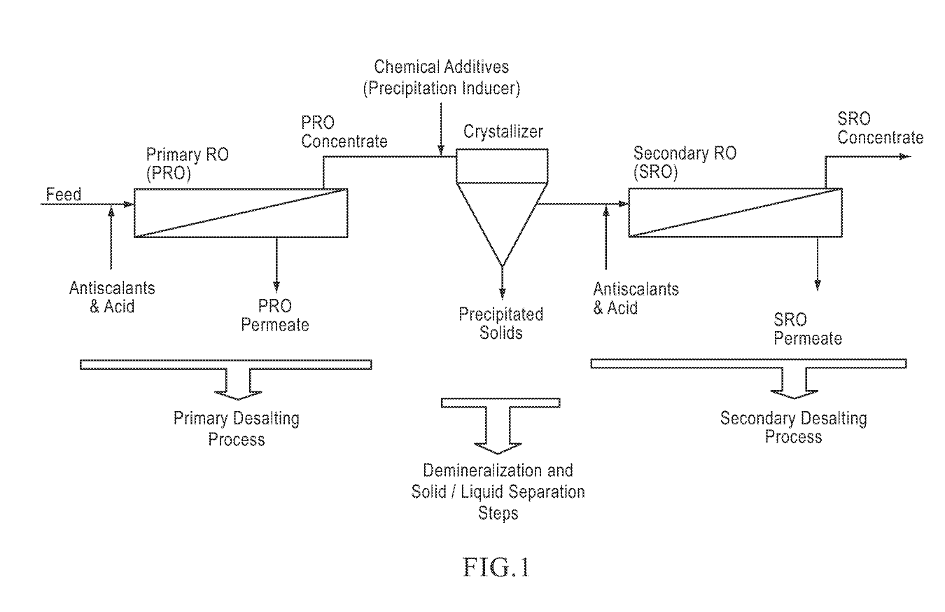

In one embodiment, as illustrated schematically in FIG. 1, the process includes a primary desalting step, a chemical demineralization step, a solid/liquid separation step, and a secondary desalting step.

In one embodiment, the primary desalting step (carried out using a primary desalting module or unit) includes the desalting of an aqueous feed solution stream using a membrane-based separation method that produces a low-salinity stream (primary product stream) and a concentrated stream (primary concentrate). The primary desalting step is operated at a recovery level such that one or more sparingly soluble inorganic salts are above their solubility limits in a supersaturated state. By utilizing various membrane scaling mitigation methods and operating at or below the membrane scaling threshold limit, the inorganic salts are kept in their soluble state despite their state of supersaturation.

In one embodiment, the demineralization step includes removing antiscalants, such as polyacrylic acid, from the solution and contacting the solution with inorganic seeds to induce gypsum precipitation. In one embodiment, the chemical demineralization step (carried out using a demineralization and separation module or unit) removes scale-inhibitors from the aqueous phase of the primary concentrate stream and desupersaturates the concentrate stream with respect to certain inorganic salt(s), producing treated primary concentrate. The removal of scale-inhibitors is achieved by contacting the primary concentrate with an adsorbent or a co-precipitant, which is directly introduced or generated in-situ. In one embodiment, the removal of the scale-inhibitors (antiscalants) is achieved by adding line or soda ash to the primary concentrate.

Desupersaturation of the primary concentrate stream is then achieved by contacting the stream with inorganic seeds, providing surface area for certain inorganic salts to crystallize/co-precipitate on the seeds. In one embodiment of the invention,

In one embodiment, the solid-liquid separation step (carried out using the demineralization and separation module or unit) serves to remove solid inorganic salts from the treated primary concentrate stream. Some of the solids can be recycled to the chemical demineralization step as recycled inorganic seeds. In one embodiment, the inorganic seeds are reduced in size to be an appropriate size. In other embodiments, this does not involve prior size reduction. The chemical demineralization and the solid/liquid separation steps form a strategy switch from the primary desalting step. Specifically, in the primary desalting step, the salts are kept in their soluble state, and, during the demineralization and the solid/liquid separation steps, the salts are precipitated and removed from the solution.

In one embodiment, the secondary desalting step (carried out using a secondary desalting module or unit) further recovers a low-salinity aqueous solution from the treated primary concentrate stream, which is the feed solution for this step. The operation of the secondary desalting step follows a similar approach as that of the primary desalting step. In some embodiments, a portion of the concentrate from the secondary desalting step is recycled to the chemical demineralization step in order to increase the overall recovery level of low-salinity aqueous solution from the initial feed solution. The secondary desalting step is a strategy switch from the demineralization and solid/liquid separation steps. Specifically, in the demineralization and solid/liquid separation steps, the salts are precipitated and removed from the solution, and, during the secondary desalting step, in some embodiments, the salts are kept in their soluble state.

In the primary and/or secondary desalting steps, the membrane-based separation methods can be reverse-osmosis (RO) and nanofiltration processes. In some embodiments, spiral wound modules are used. In some embodiments, due to economical or other factors, primary and/or secondary desalting steps use electrodialysis or electrodialysis-reversal processes. Other membrane-based desalting processes that could be used in the primary and/or secondary desalting steps include, but are not limited to, membrane distillation, forward osmosis, and advanced filtration systems that use membranes that reject inorganic salts but permeate water.

In some embodiments, membrane scaling that occurs during the primary and/or secondary desalting steps is mitigated by using one or more methods. For example, mitigation of membrane scaling in the primary and/or secondary desalting steps can be achieved by using methods including, but not limited to, the following (1) dosing of scale inhibitors into the stream; (2) adjustment of the feed solution pH to control certain inorganic salts having pH-dependent solubilities; (3) accounting/enhancing the natural actions of certain chemical species in the feed solution that can supplement the actions of scale inhibitors or pH adjustment in suppressing inorganic-salt scaling; (4) operating at a recovery level that is at or near the threshold limit of membrane scaling; and (5) automatic initiation of membrane cleaning cycle as a response to detection of fouling or membrane scaling.

In one embodiment, the feed stream is dosed with scale inhibitors (i.e., antiscalants) to mitigate membrane scaling during the primary and/or secondary processing steps. These scale inhibitors, which function by delaying nucleation of inorganic-salt crystals and subsequent growth on membranes, are typically available as commercial formulations containing polyelectrolytes, such as polyacrylates, polyphosphonates, and their derivatives.

In one embodiment, the feed solution pH is adjusted to control certain inorganic salts having pH-dependent solubilities to mitigate membrane scaling during the primary and/or secondary processing steps. This can be done using a strong acid (e.g., HCl or H₂SO₄) or a strong base (e.g., NaOH or Na₂CO₃).

In one embodiment, accounting for or enhancing the natural actions of certain chemical species in the feed solution that can supplement the actions of scale inhibitors or pH adjustment in suppressing inorganic-salt scaling. Such considerations would minimize the need for the dosing of acid, scale inhibitors, and other substances foreign to the feed stream. For example, aqueous species such as bicarbonate, which are present in many feed water sources, has been shown to retard the appearance and growth of gypsum crystals on membrane surface. Enhancing bicarbonate species concentration in the feed stream by adjusting the pH to an appropriate level may supplement the mitigation of gypsum scaling and therefore reduce the amount of scale-inhibitors used. In addition, feed waters having very high sulfate concentration have also been shown to exhibit a relatively wide metastable range of supersaturation with respect to calcium carbonate, reducing the use of acid addition for undersaturating process streams with respect to calcium carbonate.

In one embodiment, operating at a recovery level that is at or near the threshold limit of membrane scaling can mitigate the scaling. This can be ensured by installing an advanced membrane scaling monitoring system and/or utilizing an improved membrane test cell. Certain aspects of such monitoring system can be implemented as, for example, described in PCT Publication No. WO 2007/087578, published on Aug. 2, 2007 and entitled “Method and System for Monitoring Reverse Osmosis Membranes,” the disclosure of which is incorporated herein by reference in its entirety.

In some embodiments when operating at a recovery level that is at or near the threshold limit of membrane scaling or when automatically initiating a membrane cleaning cycle as a response to detection of fouling or membrane scaling, a membrane fouling/scaling monitoring method may be used. For example, in one embodiment a monitoring system that is capable of detecting the formation of mineral salt crystals on the surface of a membrane, such as an RO membrane, is used. One example of such detection method is disclosed in WO 2007/087578, the disclosure of which is incorporated herein by reference.

In one embodiment, the chemical demineralization step involves contacting the primary concentrate with an adsorbent or a co-precipitant, to specifically remove a sufficient amount of precipitation retarders, including organics and scale-inhibitor, from the aqueous phase. The adsorbent/coprecipitant can be relatively inexpensive and can contribute to fouling/scaling problems in a subsequent membrane-desalting operations after a reasonable level of solid-liquid separation. The adsorbent/co-precipitant can be introduced to the primary concentrate by various mechanisms, including direct contact of added adsorbent (e.g., MgO) or in situ generation. The latter would involve the introduction of an inexpensive precipitant (a CO₂-lean gas such as air or a reagent such as lime, NaOH, or Na₂CO₃) to precipitate certain inorganic salts in the primary concentrate stream (e.g., calcium carbonate, magnesium hydroxide, etc.) that have high adsorption affinity and/or strong ability to co-precipitate with precipitation retarders.

The amount of chemical additives (including those used for pH adjustment and gypsum crystal seeds) used is expected to be minimal as their primary purpose is not for high levels of removal of inorganic salts, but for partially removing precipitation retarders, which are typically present in primary concentrate at trace levels (e.g. 3-10 ppm, solid basis). The higher affinity of the precipitation retarders for the precipitated calcium carbonate reduces poisoning of the inorganic gypsum seeds. As a result, subsequent contact of these inorganic gypsum seeds to primary concentrate stream serves to provide high surface areas for which certain inorganic salts can sustainably crystallize and grow, thereby providing mechanisms for high levels of removal of supersaturated inorganic salts, concentrate desupersaturation, and generation of new surface areas for crystallization. The inorganic seeds are, in some embodiments, composed of an inexpensive material (e.g., sand, powdered limestone, etc.) or an inorganic salt of the same identity as the inorganic salt being removed during the seeding process (e.g. gypsum, barium sulfate, etc.). Throughout the process of the chemical demineralization step, various inorganic salts may also be removed from the aqueous phase through co-precipitation processes with adsorbent/co-precipitant or with the inorganic seeds.

Various reactor configurations may be used to carry out the chemical demineralization step. In one embodiment, it is desirable that precipitation retarders are removed and kept from the aqueous-phase prior to the contacting of primary concentrate with inorganic seeds in order to minimize poisoning, enable generation of new seed surfaces at a favorable rate, and extend the recycling lifetime of inorganic seeds. This may include having two or more separate reactors in series or a hybrid thereof, allowing various functions to operate such as flash mixing, mixing, precipitation, flocculation, crystal growth, and sedimentation. The reactors can be of various types, including but not limited to stirred tank reactors, solids-contact reactors, fluidized-bed reactors, fixed-bed reactors, or hybrids thereof.

Prior to sending the treated primary concentrate to the secondary desalting step, the solid-liquid separation step is performed. During the solid-liquid separation step, solid processing functions are provided to remove solids from the treated aqueous stream. These functions can be provided by various mechanisms and configuration, either via a separate unit or integrated into the reactors used to perform the chemical demineralization step. In some embodiments, thickeners, settlers, media filtration, microfiltration, ultrafiltration, cyclone, etc. can be used to separate the solids from the liquid. Partial recycling of inorganic salts solids or sludge to the reactor, which would reduce the required rate of fresh inorganic seeds addition, may involve size reduction, which can be accomplished using various methods such as wet milling or high-shear mixing (e.g., rotator-stator).

Some elements of some embodiments of the invention have been successfully tested, including the following:
(a) Antiscalant removal, such as poly(acryilic) acid, by calcium carbonate adsorption/co-precipitation may occur. The amount of lime required to achieve sufficient antiscalants removal requires careful testing for each specific system. Feasibility is determined by the residence time needed for prescribed removal of the scale precursors and any interference from residual antiscalant.
(b) The concept of poly(acrylic) acid removal to allow sustainable gypsum seeding and recycle has been tested for desupersaturation of synthetic primary concentrate containing antiscalants. This finding suggests that the disclosed approach is feasible and would typically use fewer chemicals than other approaches.

In some embodiments, saline aqueous solutions are purified using a process having the following general characteristics:
(a) Capability of operating at ambient temperature; and
(b) Reduction of the volume of brine concentrate from RO desalting.

### Example

### Desalting Saline Water

One embodiment of the invention involves a process for desalting saline water of high gypsum scaling potential, typically containing high concentration of sulfate, medium concentration of calcium, and low-to-medium concentration of total carbonate. Examples of waters having such characteristics include agricultural drainage and mine waters.

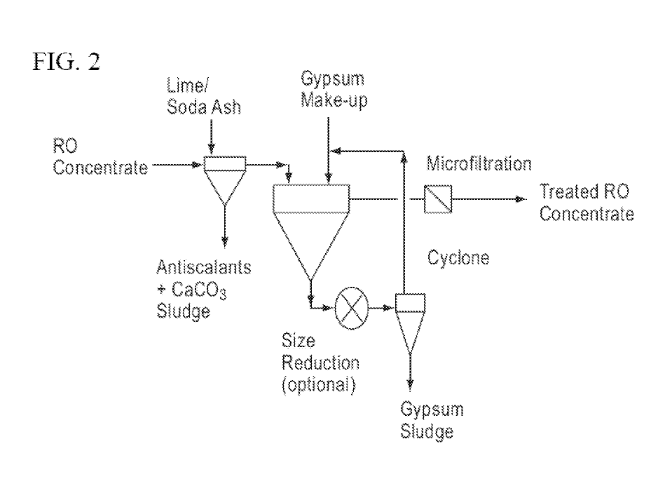

In this embodiment, the process desalts the feed water via the following steps:
(a) Tailoring of feed water composition with antiscalants, acid: The goal is to optimize the dose of these additives so that: 1) there is sufficient suppression of membrane scaling, 2) there is minimal use of chemical additives, and 3) the bicarbonate species concentration is sufficiently high to supplement suppression of gypsum scaling, but sufficiently low that calcium carbonate scaling does not occur.
(b) Primary desalting of the tailored feed water using either reverse osmosis, nanofiltration, electrodialysis-reversal, or combination thereof.
(c) Inducing the precipitation of calcium carbonate from the primary desalting concentrate stream, preferably in a solids-contact reactor whereby calcium carbonate solids are maintained in solution to act as seeds: The purpose is to remove antiscalants by adsorption/co-precipitation with calcium carbonate. Therefore, calcium carbonate precipitation can be used simply up to an extent that leads to sufficient removal of antiscalants (a trace component of the solution), not calcium (a major component of the solution). As illustrated in FIG. 2, calcium carbonate precipitation can be induced by various mechanisms, including addition of lime, soda ash (as illustrated in FIG. 2). Sufficient residence time is allowed for antiscalants removal before primary desalting concentrate is sent to the next step. Some calcium carbonate solids may be removed via solid-liquid separation (e.g., sedimentation) before proceeding to the next step.
(d) Gypsum seeds are introduced into the primary concentrate stream (as illustrated in FIG. 2), preferably in a solids-contact reactor, to induce gypsum crystal growth and therefore primary concentrate desupersaturation: Gypsum solids of a given size distribution is maintained in the reactor by way of continual removal of large solids, addition of fresh solids, and recycle of the precipitated solids; solids-liquid separation is achieved by gravity (sedimentation) and/or using cyclones. Depending on operating conditions, recycling of gypsum solids/sludge may involve size reduction to increase surface-area-to-mass ratio of the solids.
(e) Supernatant from the reactor is filtered, preferably by way of membrane microfiltration.
(f) The composition of the treated and filtered primary concentrate is tailored as step (a) and become secondary desalting feed stream.
(g) Secondary desalting feed stream using the same approach as step (b): A proportion of the resulting secondary desalting concentrate is recycled to the beginning of step (c) in order to increase overall water recovery of the process.

Primary and secondary desalting is designed and operated such that the quality of the combined product water from these two steps meet end-user specifications.

### Other Examples and Data

In one example, water of the San Joaquin Valley (California) was studied. The San Joaquin Valley is one of the world's most productive agricultural regions. It is a closed basin with naturally saline soil and shallow impermeable shale. Geology and irrigation lead to rising groundwater salinity and threatens productivity. The salinity of the water is about 1500 to 30,000 TDS (total dissolved solids). Artificial drainage is used to reduce salt build-up. Disposal is constrained by limited inland disposal sites and strict environmental regulations. High recovery desalination is a potential solution to reclaim water and reduce disposal volumes.

The objectives include enhancing the recovery of high sulfate brackish water and to determine process requirements for high recovery RO desalination of inland brackish water. Also, the objectives include operating a primary RO at the highest sustainable recovery using antiscalants (maximize permeate and minimize brine production and produce supersaturated brine streams), inducing precipitation of scale precursors between stages (antiscalant removal) (e.g., high carbonate waters), gypsum seeding (e.g., low carbonate waters), and operating secondary RO at highest sustainable recovery using antiscalants (high overall recovery and low brine volume).

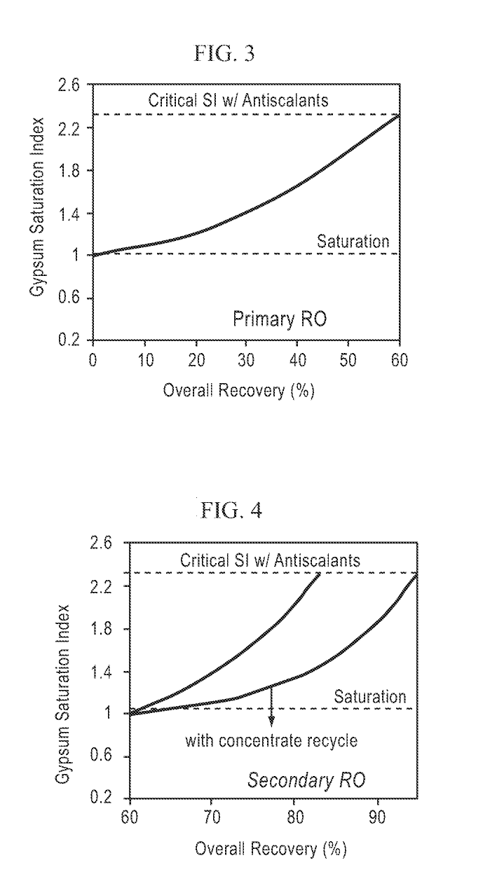

FIGS. 3 and 4 illustrate the recovery vs. the gypsum saturation index (SI) of the primary desalting step (a reverse osmosis process) and the secondary desalting step, respectively, via accelerated gypsum precipitation.

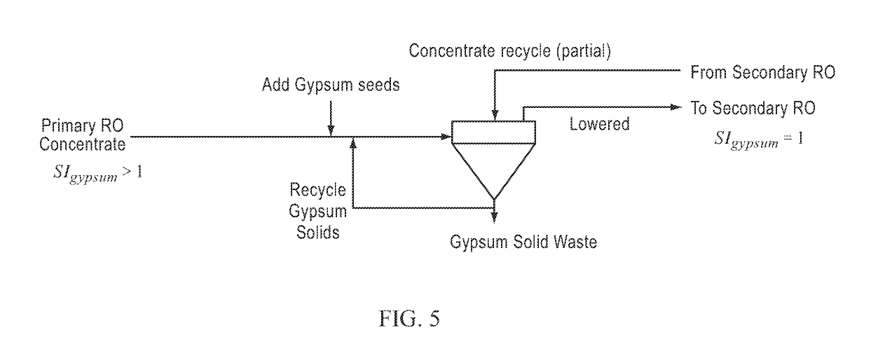

FIG. 5 is an example of a process for accelerated gypsum precipitation for a primary desalting step concentrate desupersaturation.

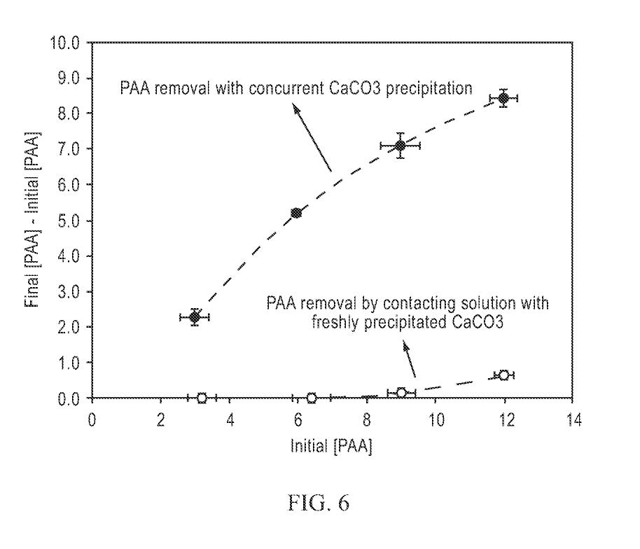

FIG. 6 illustrates the removal of polyacrylic acid (PAA), which is an active ingredient of some antiscalants, by CaCO₃. The precipitation of CaCO₃ in solution containing PAA will result in a high amount of PAA removal. In some embodiments, adding fresh CaCO₃ precipitate to absorb PAA may be undesirable from an efficiency standpoint. In such embodiments, PAA removal occurs concurrently with CaCO₃ precipitation.

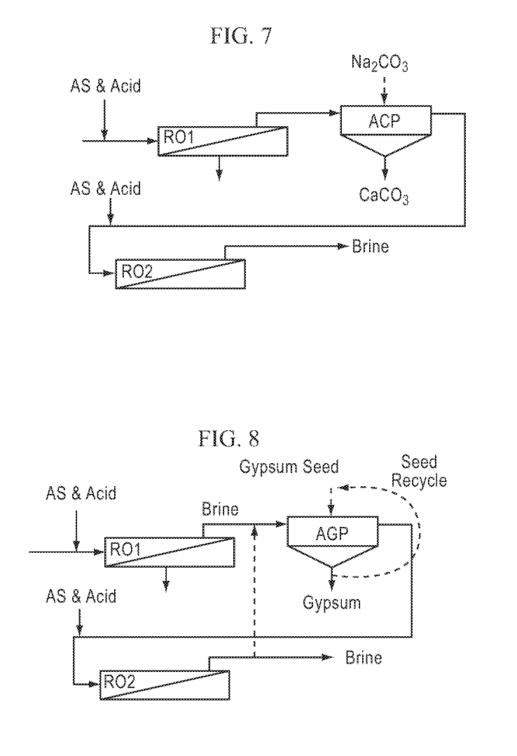

FIG. 7 illustrates a process for water recovery (water desalination) via accelerated chemical precipitation. In this embodiment, antiscalants (AS) and acid are added prior to the RO steps (RO1 and RO2). FIG. 8 illustrates a process for water recovery (water desalination) via accelerated gypsum precipitation. In this embodiment, antiscalants and acid are added prior to the RO steps (RO1 and RO2).

One challenge with respect to accelerated gypsum precipitation is that the solution contains antiscalants. In some embodiments, the antiscalants “poison” or foul the gypsum seeds. Thus, in some embodiments, the removal of the antiscalants (i.e., via inducing the precipitation of calcium carbonate after the first desalting step), aids in preventing the poising of the gypsum seeds.

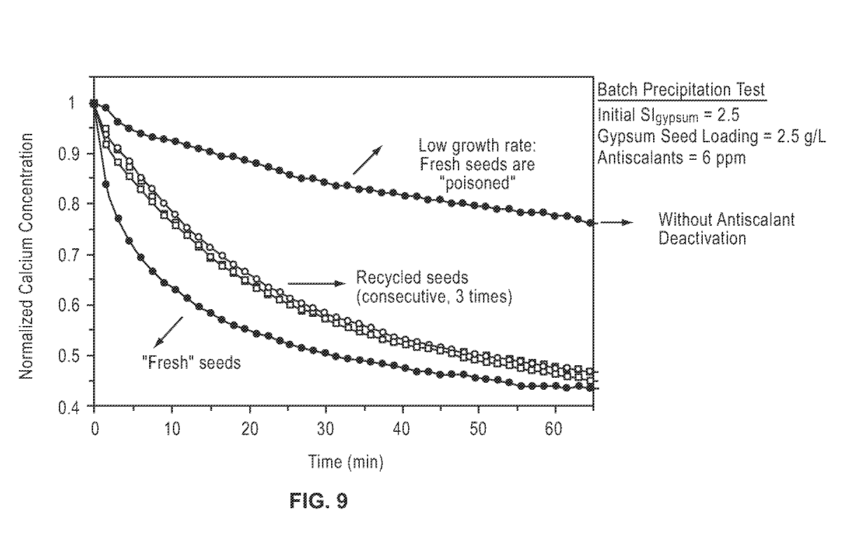

FIG. 9 illustrates the results of desupersatuation of the solution by gypsum seeding (normalized calcium concentration vs. the time).

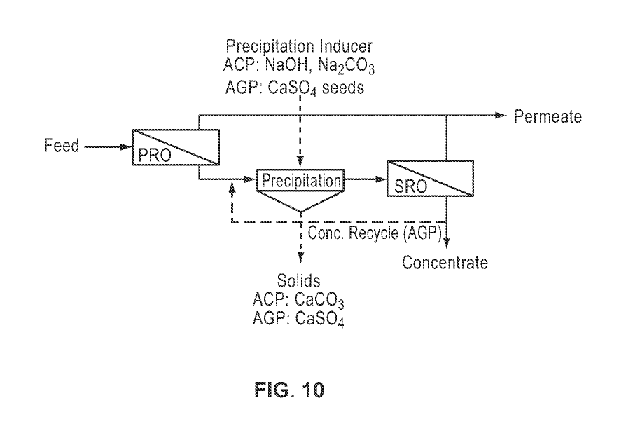

FIG. 10 illustrates that antiscalant deactivation is desirable for feasible operation of accelerated gypsum precipitation. In one embodiment, Na₂CO₃ was added via alkaline dosing in accelerated chemical precipitation to increase thermodynamic driving force and overcome precipitation inhibition due to antiscalant carry-over. In another embodiment, CaSO₄ seeding was added in accelerated gypsum precipitation to increase kinetics of precipitation by providing large surface area for heterogenous crystallization.

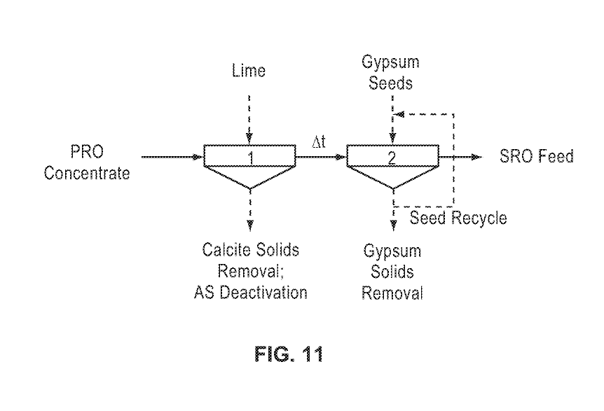

FIG. 11 illustrates an accelerated gypsum precipitation process with antiscalant deactivation followed by gypsum seeding. In this embodiment, the batch process was shown to be feasible and the recycling of gypsum seeds was possible.

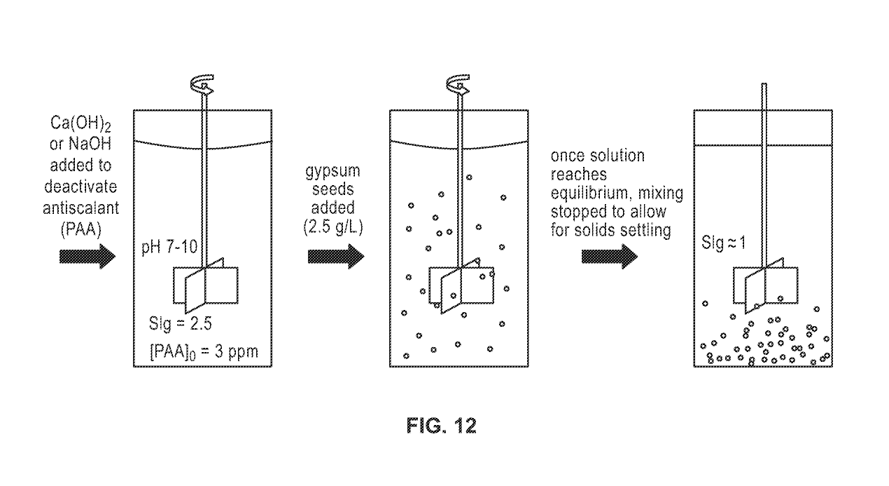

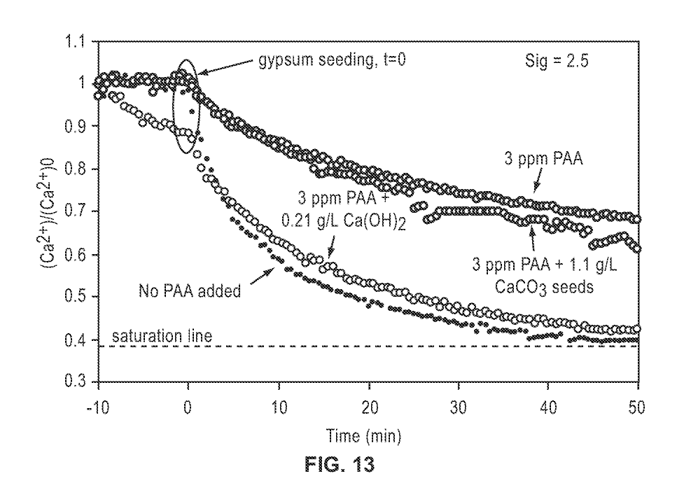

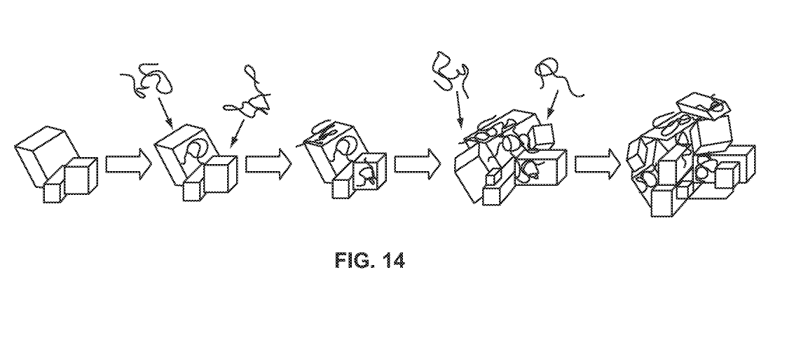

FIG. 12 illustrates the deactivation of antiscalant polyacrylic acid (PAA) by adding Ca(OH)₂ or NaOH and gypsum seeds to the mixture. FIG. 13 illustrates the timing of antiscalant polyacrylic acid (PAA) removal. FIGS. 14 and 14A illustrate the polyacrylic acid deactivation and its results. In this embodiment, 70-80% PAA removal was achieved when model solution containing PA was dosed with lime. In this embodiment, 0-15% PAA removal was achieved when PAA is added to model solution after lime dosing. In this embodiment, PAA was not removed by adsorption to CaCO₃ alone, but was also coprecipitated.

It was shown that PAA can be effectively deactivated prior to AGP. AGP kinetics are greatly improved after AS deactivation. Batch process was shown to be feasible, and recycling of gypsum seeds is possible.

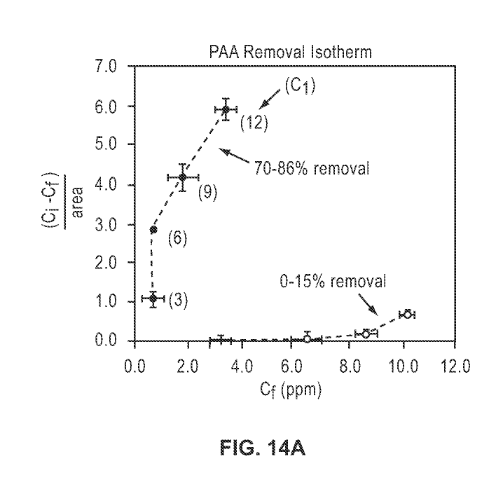

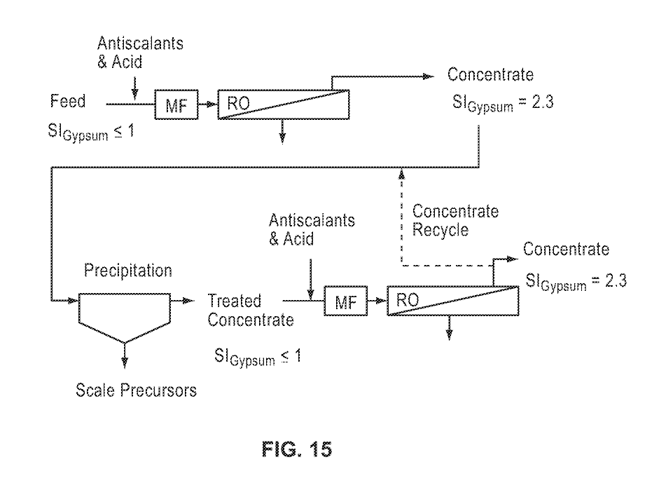

FIG. 15 illustrates product water recovery enhancement (>85%) by integrating chemical precipitation to reduce saturation index of membrane mineral scalants.

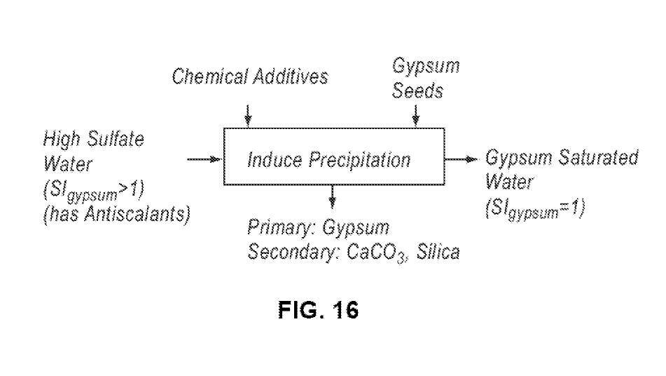

FIG. 16 illustrates a process of desupersaturation according to an embodiment of the invention. In some embodiments, there are advantages and disadvantages to performing concentrate desupersaturation via accelerated gypsum precipitation (AGP). In this embodiment, the advantages are 1) concurrent sulfate and calcium removal; In this embodiment, the disadvantages are 1) gypsum scale mitigation should be present during membrane desalting(e.g., Antiscalants); and 2) should “turn off” antiscalants action.

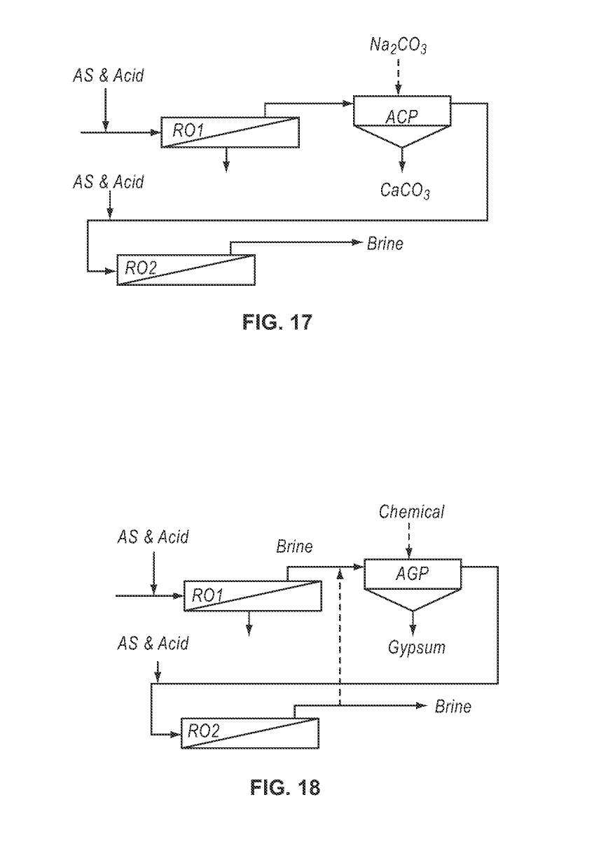

FIG. 17 illustrates the process simulation of ACP. In this embodiment, the target was 95% overall recovery and <500 mg/L permeate TDS. In this embodiment, the basis was OAS 2548 Feed Water; 1 MGD Feed, TDS=11,020 mg/L; and 9 GFD Permeate Flux. In this embodiment, the results were Pressure RO1=180 psi; Pressure RO2=660 psi; Energy=136 kW; Alkaline=1.28 kmol; Recovery RO1=60%; and Recovery RO2=87%.

FIG. 18 illustrates the process simulation of AGP. In this embodiment, the target was 95% overall recovery and <500 mg/L permeate TDS. In this embodiment, the basis was OAS 2548 Feed Water; 1 MGD Feed; and 9 GFD Permeate Flux. In this embodiment, the results were Pressure RO1=180 psi; Pressure RO2=670-700 psi; Energy=162-166 kW; Chemical=0.24-0.95 kmol; Recovery RO1=60%; Recovery RO2=66%; and Conc. Recycle=57-59%.

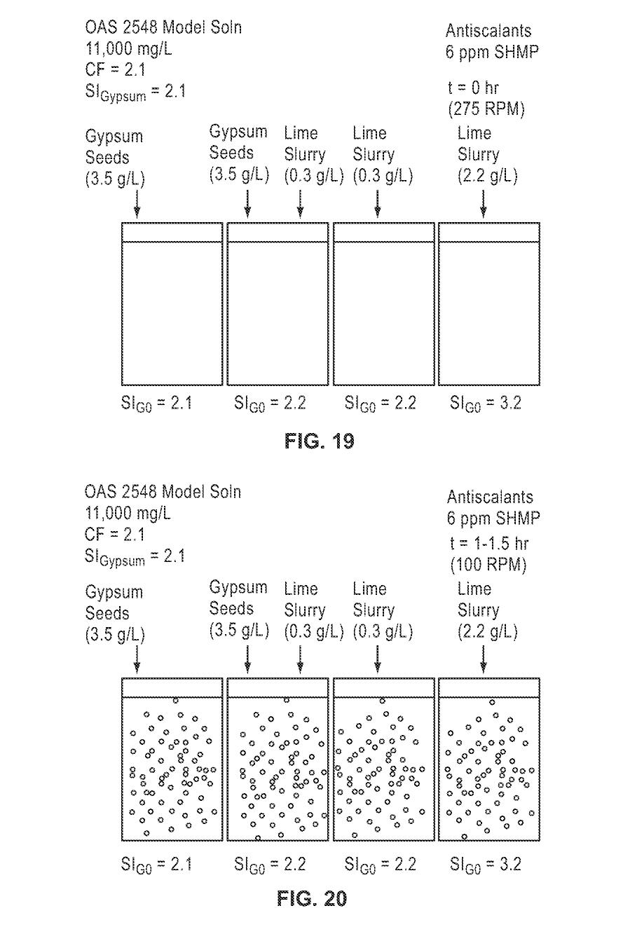

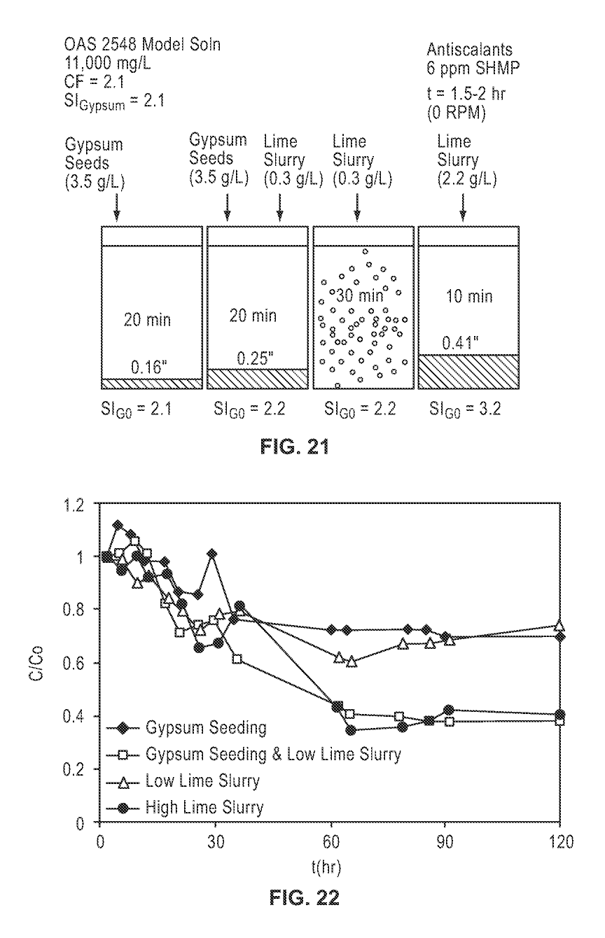

FIGS. 19-21 illustrate processes for accelerated gypsum precipitation according to embodiments of the invention.

FIG. 22 is a plot that illustrates concentration changes.

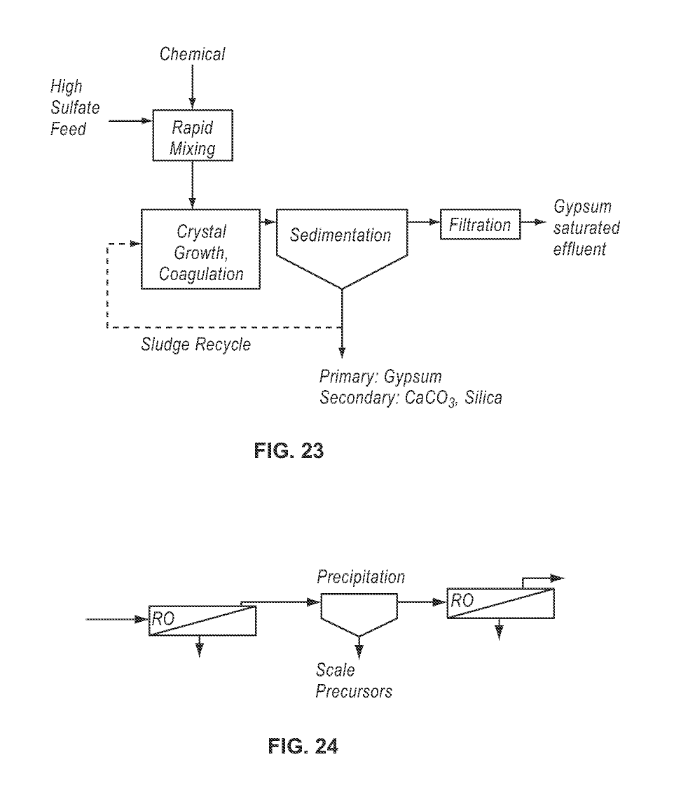

FIG. 23 illustrates an accelerated gypsum precipitation process according to an embodiment of the invention. In this embodiment, chemical selection was used to increase the rate of precipitation and deactivation of antiscalants. Additionally, in this embodiment, crystal size distribution was used to affect the efficiency of solid-liquid separation and rate of precipitation (seeding).

FIG. 24 illustrates a process for water desalination according to an embodiment of the invention. Water recovery levels of inland brackish water desalination by reverse osmosis can be enhanced significantly by precipitation of mineral salts in inter-stage streams of reverse osmosis membrane units.

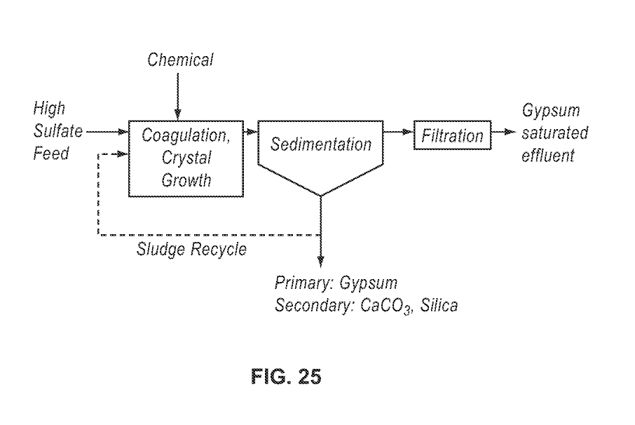

FIG. 25 illustrates an accelerated gypsum precipitation process according to an embodiment of the invention. In this embodiment, chemical selection was used to increase the rate of precipitation and to deactivate antiscalants. In this embodiment, crystal size distribution was used to affect the efficiency of solid-liquid separation and rate of precipitation (seeding).

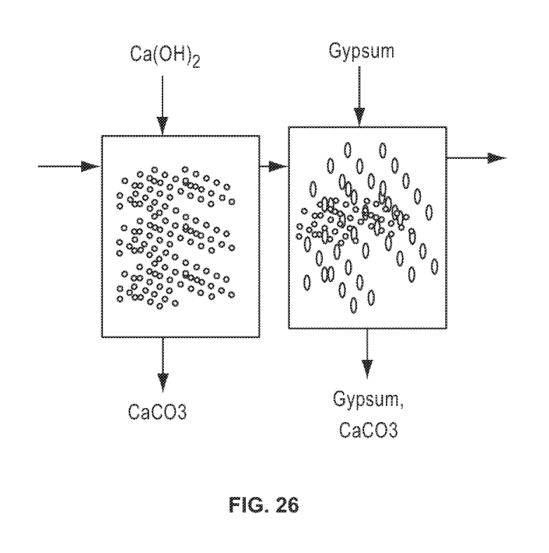

FIG. 26 illustrates a demineralization process according to an embodiment of the invention.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A method of desalting an aqueous solution, comprising:
performing a demineralization process on a concentrate solution to produce a demineralized solution, the demineralization process including contacting the concentrate solution with chemical additives to increase the pH and cause calcium carbonate precipitation followed by the addition of inorganic gypsum seeds; and
performing a desalting process on the demineralized solution.

2. The method of claim 1, the desalting process being a first desalting process, further comprising:
performing a second desalting process on the aqueous solution using a membrane to produce a desalted solution and the concentrate solution prior to the performing a demineralization process.

3. The method of claim 2, further comprising:
adding polyacrylic acid antiscalants to the aqueous solution prior to the performing the second desalting process.

4. The method of claim 2, further comprising:
treating the aqueous solution with polyacrylic acid based antiscalants and acid, prior to the performing the second desalting process.

5. The method of claim 1, wherein the performing desalting process includes performing a reverse osmosis process.

6. The method of claim 1, further comprising:
adding polyacrylic antiscalants to the demineralized solution prior to the performing a desalting process.

7. The method of claim 1, further comprising:
performing a separation process after the performing the demineralization process.

8. The method of claim 1, wherein the inorganic seeds are gypsum seeds.

9. The method of claim 1, wherein the chemical additives include calcium carbonate.

10. A method of recovering an aqueous solution, comprising:
performing a first membrane desalination process on a feed stream to produce a permeate stream and a concentrate stream;
performing a demineralization process on the concentrate stream to produce a solid phase and a liquid phase, the demineralization process including adding at least one of an adsorbent and a co-precipitant to the concentrate stream and adding inorganic seeds to the concentrate stream;
separating the solid phase from the liquid phase; and
performing a second membrane desalination process on the liquid phase.

11. The method of claim 10, wherein the inorganic seeds are gypsum seeds.

12. The method of claim 10, further comprising:
treating the feed steam with at least one of a polyacrylic acid antiscalant and an acid prior to the performing the first membrane desalination process.

13. The method of claim 10, wherein the first membrane desalination process is a reverse osmosis process.

14. A method of desalting, comprising:
performing a separation process on a feed stream to produce a permeate stream and a concentrate stream; and
performing a demineralization process on the concentrate stream to produce a solid phase and a liquid phase, the demineralization process includes inducing calcium carbonate precipitation and contacting the concentrate stream with gypsum seeds.

15. The method of claim 14, the separation process being a first separation process, further comprising:
performing a second separation process on the liquid phase after the performing a demineralization process.

16. A method of treating an aqueous solution, comprising:
removing polyacrylic acid antiscalants from the aqueous solution;
contacting the aqueous solution with inorganic seeds; and
performing a separation process on the aqueous solution.

17. The method of claim 16, wherein the inorganic seeds are gypsum seeds.

18. The method of claim 16, wherein the removing polyacrylic acid antiscalants includes adding one of lime and soda ash to the aqueous solution.

19. The method of claim 16, further comprising,
performing a liquid-solid separation after the contacting the aqueous solution with inorganic gypsum seeds to produce a solid phase and a liquid phase; and
adding antiscalants to the liquid phase.
